(19) United States
(12) Patent Application Publication
(10) Pub. No.: US 2016/0368316 A1
(43) Pub. Date: Dec. 22, 2016

(54) WHEEL BEARING UNIT

(71) Applicant: SCHAEFFLER TECHNOLOGIES AG & CO. KG, Herzogenaurach (DE)

(72) Inventors: Andreas Kaiser, Werneck (DE); Markus Reuter, Wurzburg (DE); Frank Eichelmann, Donnersdorf (DE); Roland Langer, Schwanfeld (DE); Jonas Lang, Schwebheim (DE); Ralf Heiss, Nurnberg (DE)

(73) Assignee: Schaeffler Technologies AG & Co. KG, Herzogenaurach (DE)

(21) Appl. No.: 15/117,561

(22) PCT Filed: Jan. 22, 2015
(86) PCT No.: PCT/DE2015/200014

§ 371 Date: Aug. 9, 2016

(30) Foreign Application Priority Data
Mar. 10, 2014 (DE) 10 2014 204 334.4

(51) Int. Cl. B60B 27/00; F16C 33/72; F16C 33/78; F16C 19/18

(52) U.S. Cl. CPC B60B 27/0005; F16C 19/186; F16C 33/723; F16C 33/783; B60B 27/0068; B60B 27/0073; B60B 27/0084; F16C 2326/02; B60B 2900/511

(57) ABSTRACT

Wheel bearing unit having a wheel hub, wherein the wheel hub has, at one end thereof, an integrally configured wheel flange and an inner ring which can be rotated together with the wheel hub, wherein the inner ring is fastened on the wheel hub by a rolling rivet flange, in order to prestress a rolling body row with respect to an outer ring, and having an encoder which is provided on the inner ring and extends radially in the direction of the outer ring, and having a protective covering which is fixed on the outer ring, in order to close and to seal annular openings which are configured between the outer ring and the wheel hub, wherein the protective covering is pressed in with a cylindrical section and is connected in an integrally joined manner to the outer ring, and wherein a bottom section extends inwards in the radial direction from the cylindrical section, in order to cover an inner-side end of the wheel hub.

### FIELD OF THE INVENTION

The invention relates to a wheel bearing unit especially for motor vehicles.

### BACKGROUND

Rolling riveted wheel bearing units have been used for passenger cars in the past in a large variety. Basic non-driven wheel bearing units are moving toward use in connection with vehicle-side covers that can take over a large part of the axial-side sealing function. In connection with sensor wheel bearing units that can detect or measure, for example, wheel rotational speeds, these cover closures are advantageous. Through such cover closures it is no longer necessary to provide another seal. Covers with mounted sensors are made from a magnetic material, at least in the sensor area, which is why stainless steel covers are often used.

From DE 11 2011 100 942 T5, a wheel bearing unit with a cover is known in which the cover is formed with a section that is pressed into the vehicle-side end of an outer ring. Between the outer ring and the cover there is an elastic element that is pressed in with the cover and deformed elastically.

EP 2 047 131 B1 discloses a wheel bearing unit that has a cover for sealing the bearing. The cover is mounted with a section on an outer circumferential surface of an outer ring.

### SUMMARY

The invention is based on the objective of providing a wheel bearing unit that guarantees a secure seal.

This object is achieved according to the invention by a wheel bearing unit with a wheel hub, wherein the wheel hub has, on one end, an integrally formed wheel flange and an inner ring that can rotate together with the wheel hub, wherein the inner ring is mounted by a rolling rivet flange on the wheel hub, in order to pretension a rolling body row relative to an outer ring, and with an encoder that is provided on the inner ring and extends radially in the direction of the outer ring and with a protective covering that is fixed on the outer ring, in order to close and seal annular openings that are formed between the outer ring and the wheel hub, wherein the protective covering is pressed in with a cylindrical section and is connected with an adhesive bond to the outer ring and a bottom section extends inward in the radial direction from the cylindrical section, in order to cover an inner end of the wheel hub.

In the wheel bearing unit according to the invention, for sealing the annular opening between the outer ring and wheel hub there is a protective covering. This protective covering is pressed into the outer ring with a cylindrical section. After the pressing, the protective covering is connected to the outer ring with an adhesive bond. Depending on production and due to the pressing, grooves, channels, etc., which cause gaps between the protective covering and the outer ring are formed on the protective covering. A liquid is “injected” into these gaps, which connects the protective covering and the outer ring to each other with an adhesive bond and closes the gaps. It is advantageous here that a captive connection is created between the protective covering and outer ring. In addition, a seal that enables a secure sealing of the wheel bearing unit is created by the adhesive bond connection. This means that the penetration of rain water or dust from the outside into the bearing is prevented.

According to one construction of the invention, the protective covering is pressed with the cylindrical section onto an inner circumference of the outer ring. Alternatively, the protective covering is pressed in with the cylindrical section onto an outer circumference of the outer ring. According to requirements or the available installation space, the protective covering is pressed onto the inner circumference or the outer circumference of the outer ring.

According to one construction of the invention, the adhesive bond connection is created by a setting liquid. This setting liquid is injected into the resulting gaps after the pressing in of the protective covering. The liquid (e.g., an adhesive, anaerobic adhesive, or a lacquer) sets after it is applied, whereby a fixed connection between the protective covering and the outer ring is created. For setting, advantageously a UV light source can be provided.

According to one construction of the invention, the protective covering is formed from a non-ferromagnetic material. In this way, negative effects on the magnetic flux can be prevented.

Preferably, the protective covering has a saucer-like shape and is formed by stamping. Through such a construction of the protective covering, the rigidity can be increased and deformation due to the impacts of gravel, etc. can be reduced.

In one construction of the invention, a rotational speed sensor is provided for detecting the rotational speed of the wheel hub, wherein the rotational speed sensor and the encoder are arranged opposite each other with a predetermined air gap in the axial direction over the bottom section.

### BRIEF DESCRIPTION OF THE DRAWINGS

An embodiment of the invention is described below with reference to a FIGURE. Shown is:

FIG. 1 a partial longitudinal section through a wheel bearing unit according to the invention.

### DETAILED DESCRIPTION OF THE PREFERRED EMBODIMENTS

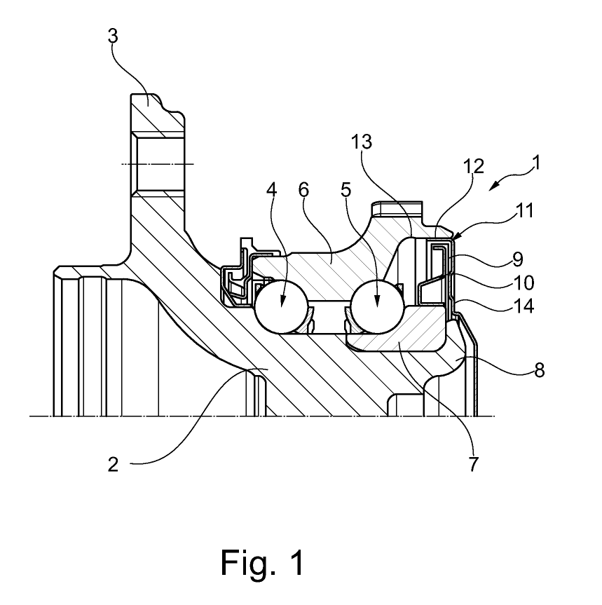

FIG. 1 shows a wheel bearing unit 1 that is allocated to a not-shown vehicle wheel. The wheel bearing unit 1 comprises a wheel hub 2 that has, on its end, an integrally formed, radially directed wheel flange 3. The wheel bearing arrangement further has two axially spaced rolling body rows 4, 5, whose rolling bodies are guided on the outside in an outer ring 6. On the inside, the rolling bodies of the rolling body row 4 are guided directly in a raceway of the wheel hub 2 and the rolling bodies of the rolling body row 5 are guided in an inner ring 7 fixed on the wheel hub 2.

The inner ring 7 is mounted by a rolling rivet flange 8 axially on the wheel hub 2, whereby the rolling body row 5 is pretensioned relative to the outer ring 6.

As can be further seen from FIG. 1, on an outer circumference of the inner ring 7 there is an encoder 9. The encoder 9 is provided on a carrier 10 by which the encoder 9 is connected to the outer circumference of the inner ring 7. The encoder 7 is formed of an elastomer material, filled with magnetic particles that are connected integrally to the carrier 10 by vulcanization.

For sealing an opening between the outer ring 6 and the wheel hub 2, a protective covering 11 is provided that is constructed from a non-ferromagnetic material by stamping. The protective covering 11 is pressed in with a cylindrical section 12 on an inner circumference 13 of the outer ring 6. A bottom section 14 extends inward in the radial direction from the cylindrical section 12, in order to cover an inner end of the wheel hub 2.

Depending on production and due to the pressing, grooves, channels, etc., which create gaps between the protective covering 11 and outer ring 6 are produced on the protective covering 11. A setting liquid is “injected” into these gaps, which connects the protective covering 11 and the outer ring 6 to each other with an adhesive bond and seals the gaps.

### LIST OF REFERENCE NUMBERS

1 Wheel bearing unit
2 Wheel hub
3 Wheel flange
4 Rolling body row
5 Rolling body row
6 Outer ring
7 Inner ring
8 Rolling rivet flange
9 Encoder
10 Carrier
11 Protective covering
12 Cylindrical section
13 Inner circumference
14 Bottom section

1. A wheel bearing unit comprising a wheel hub having on one end, an integrally constructed wheel flange, an outer ring, a rolling body row, an inner ring that is rotatable together with the wheel hub the inner ring is mounted by a rolling rivet flange on the wheel hub, in order to pretension the rolling body row relative to the outer ring, an encoder is provided on the inner ring that extends radially in a direction of the outer ring, a protective covering that is fixed on the outer ring to close and seal annular openings that are formed between the outer ring and the wheel hub, the protective covering has a cylindrical section that is pressed in and connected with an adhesive bond to the outer ring and a bottom section that extends inward in a radial direction from the cylindrical section, in order to cover an inner end of the wheel hub.

2. The wheel bearing unit according to claim 1, wherein the protective covering is pressed in with the cylindrical section against an inner circumference of the outer ring.

3. The wheel bearing unit according to claim 1, wherein the protective covering is pressed in with the cylindrical section against an outer circumference of the outer ring.

4. The wheel bearing unit according to claim 1, wherein the adhesive bond connection is formed by a setting liquid.

5. The wheel bearing unit according to claim 1, wherein the protective covering is formed from a non-ferromagnetic material.

6. The wheel bearing unit according to claim 1, wherein the protective covering has a stamped, saucer-shaped part.

7. The wheel bearing unit according to claim 1, further comprising a sensor for detecting a rotational speed or a direction of rotation of the wheel hub, and the sensor and the encoder are arranged opposite each other with a predetermined air gap in an axial direction over the bottom section.
